(19) United States
(12) Patent Application Publication
(10) Pub. No.: US 2005/0047631 A1
(43) Pub. Date: Mar. 3, 2005

(54) Method and apparatus for rolled fingerprint image capture with variable blending

(75) Inventor: Gregory Zyzdryn, Palm Beach Gardens, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/647,471

(22) Filed: Aug. 26, 2003

(51) Int. Cl. G06K 9/00

(52) U.S. Cl. 382/124

(57) ABSTRACT

A composite image of a finger rolling relative to an imaging device is generated by stitching together image data from a plurality of image frames. The areas of each image that contain useful fingerprint information are identified and the speed of movement of the finger relative to the imaging path is determined. The frames are stitched together in sequence and data for pixels near the boundary between adjacent images is blended, so that values for those pixels are determined based on redundant data from both adjacent images. The extent of blending is based at least in part on movement speed of the finger, so that as speed increases blending is applied to an increasing number of the pixels in the boundary area. Blending may be accomplished using a weighting function where data from a primary frame is given primary weight while data from a secondary or redundant frame is given relatively less weight, and weight given to pixels from the secondary frame declines as distance increases between those pixels and the boundary between frames.

### BACKGROUND OF THE INVENTION

1. Field of the Invention

The present invention is directed to the field of rolled fingerprint capture, and more specifically, to capturing and combining multiple fingerprint images to generate a composite rolled fingerprint image.

2. Related Art

A rolled fingerprint scanner is a device used to capture rolled fingerprint images. The scanner captures the image of a user's fingerprint as the user rolls a finger across an image capturing surface. Multiple fingerprint images may be captured by the scanner as the finger is rolled. These images are then combined using a computer to form a composite rolled fingerprint image. Fingerprint images captured by a digital camera are generally comprised of pixels. Combining the pixels of multiple fingerprint images into a composite fingerprint image is commonly referred to as pixel “knitting.”

The captured composite rolled fingerprint image constitutes biometric data for the user. A biometric is a unique, measurable characteristic or trait of a human being for automatically recognizing or verifying identity. Fingerprint biometrics are well-established as an accurate method of identification and verification.

Capturing rolled fingerprints using a fingerprint scanner coupled to a computer may be accomplished in a number of ways. Many current technologies implement a guide to assist the user. These guides primarily come in two varieties. The first type includes a guide located on the fingerprint scanner itself. This type may include guides such as light emitting diodes (LEDs) that move across the top and/or bottom of the scanner. The user is instructed to roll the finger at the same speed as the LEDs moving across the scanner. In doing so, the user inevitably goes too fast or too slow, resulting in poor quality images. The second type includes a guide located on a computer screen. Again, the user must match the speed of the guide, with the accompanying disadvantages.

Various devices have been developed for collecting rolled fingerprint images. For instance, U.S. Pat. No. 4,933,976 describes using the statistical variance between successive fingerprint image “slices” to knit together a composite fingerprint image. This patent also describes techniques for averaging successive slices into the composite image. These techniques have the disadvantage of less than desirable image contrast.

U.S. Pat. No. 6,483,932, assigned to Cross Match Technologies, Inc., discloses a useful method for capturing rolled fingerprint images. The method detects the start of the “roll” and a plurality of image frames are captured until the roll is completed. Pixels of each frame are then knitted into a composite fingerprint image.

Conventional efforts to knit image portions into composite fingerprint images typically result in image discontinuities, particularly where image portions overlap and provide different pixel values for overlapping areas. Discontinuities appear particularly at points where ridge features meet in adjacent image portions. There is a need for an improved method of establishing pixel values at the boundaries of these image portions as they are knitted into a composite print image.

### SUMMARY OF THE INVENTION

The invention provides an improved system and method for creating a composite image of a moving object by stitching together image data from a plurality of image frames containing image data for the object. In an embodiment, a plurality of fingerprint images are captured as a finger is rolled relative to an imaging device. The areas of each image that contain useful fingerprint information are identified and the speed of movement of the finger relative to the imaging path is determined. The images are stitched together in sequence and data for pixels near the boundary between adjacent images is blended, so that values for those pixels are determined based on redundant data from both adjacent images. The extent of blending is determined based at least in part on the speed of movement of the finger, so that as speed increases blending is applied to an increasing number of the pixels in the boundary area. Blending in this embodiment occurs based on a weighting function where data from a primary frame is given primary weight while data from a secondary or redundant frame is given relatively less weight. The weight given to pixels from the secondary frame declines as distance increases between those pixels and the boundary between frames.

Further embodiments, features, and advantages of the present invention, as well as the structure and operation of the various embodiments of the present invention, are described in detail below with reference to the accompanying drawings.

### BRIEF DESCRIPTION OF THE DRAWINGS

FIG. 1 is a block schematic diagram of one embodiment of a fingerprint scanning hardware arrangement useful in implementing the processing methods of the present invention.

FIG. 2 is a side sectional view of an optical imaging apparatus used in the scanning system of FIG. 1.

FIG. 3 is a flow chart for an embodiment of a method of capturing rolled fingerprint images with variable blending.

FIG. 4a is a diagram showing an imaging surface used in an embodiment of the present invention.

FIG. 4b is a series of images of the imaging surface of FIG. 4a as a finger is rolled across the imaging surface.

FIG. 4c shows a region of the imaging surface over which the fingertip is rolled during roll print capture.

FIG. 4d is an illustration showing the spatial relationship on the imaging surface of two sequential fingertip images taken as the finger rolls across the surface, and the location of a blending region.

FIG. 4e is a magnified view of the blending region shown in FIG. 4d.

The present invention will now be described with reference to the accompanying drawings. In the drawings, like reference numbers can indicate identical or functionally similar elements. Additionally, the left-most digit(s) of a reference number may identify the drawing in which the reference number first appears.

### DETAILED DESCRIPTION OF THE PREFERRED EMBODIMENTS

The present invention provides an improved apparatus and method for combining image data to form a composite image. The invention will be described by way of example in terms of a system and method for creating composite fingerprint images.

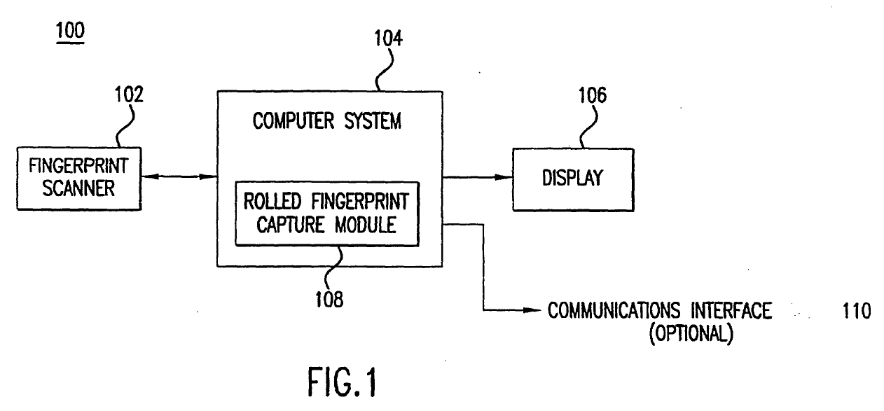

FIG. 1 is an exemplary high-level block diagram of a hardware embodiment useful in implementing the present invention. As can be seen, FIG. 1 shows a rolled fingerprint capture apparatus 100 including a fingerprint scanner 102, a computer system 104, and a display 106.

Fingerprint scanner 102 captures a user's fingerprint. Fingerprint scanner 102 may be any suitable type of fingerprint scanner, known to persons skilled in the relevant art(s). For example, fingerprint scanner 102 may be a Cross Match Technologies Verifier™ 290 fingerprint capture device. Fingerprint scanner 102 includes a fingerprint image capturing area or surface, where a user may apply a finger, and roll the applied finger across the fingerprint capturing area or surface. Fingerprint scanner 102 periodically samples the fingerprint image capturing area, and outputs captured image data from the fingerprint image capturing area. Fingerprint scanner 102 is coupled to computer system 104.

Fingerprint scanner 102 may be coupled to computer system 104 in any number of ways. Some of the more common methods include coupling by a frame grabber, a Universal Serial Bus port, and a parallel port. Other methods of coupling fingerprint scanner 102 to computer system 104 are known to persons skilled in the relevant art(s), and are within the scope of the present invention.

Computer system 104 receives captured fingerprint image data from fingerprint scanner 102. Computer system 104 may provide a sampling signal to fingerprint scanner 102 that causes fingerprint scanner 102 to capture fingerprint image frames. Computer system 104 combines data from a plurality of captured fingerprint image frames to generate a data set representing a composite fingerprint image. Further details of combining captured fingerprint image frames into composite or overall fingerprint images are provided below.

Computer system 104 may comprise a personal computer, a mainframe computer, one or more processors, specialized hardware, software, firmware, or any combination thereof, and/or any other device capable of processing the captured fingerprint image data as described herein. Computer system 104 may comprise a hard drive, a floppy drive, memory, a keyboard, a computer mouse, and any additional peripherals known to person(s) skilled in the relevant art(s), as necessary. Computer system 104 allows a user to initiate and terminate a rolled fingerprint capture session and to modify rolled fingerprint capture session options and parameters.

Computer system 104 may be optionally coupled to a communications interface 110. If equipped with communications interface 110, computer system 104 may use communications interface 110 to transmit fingerprint image data, or any other related data, and to receive data needed for operations. Communications interface 110 may provide an interface to a network, the Internet, or any other data communication medium known to persons skilled in the relevant art(s). Through this communication medium, the data may be routed to any fingerprint image data receiving entity of interest, as would be known to persons skilled in the relevant art(s). For example, such entities may include the police and other law enforcement agencies. The hardware used to implement communications interface 110 depends on the type of interface desired. Communications interface 110 may, for example, comprise a modem, network card, or other network interface hardware or software appropriate to the selected data communication medium.

Display 106 is coupled to computer system 104. Computer system 104 outputs fingerprint image data, including individual frames and composite rolled fingerprint images, to display 106. Any related rolled fingerprint capture session options, parameters, or outputs of interest, may be output to display 106. Display 106 displays the received fingerprint image data and related rolled fingerprint capture session options, parameters, and outputs. Display 106 may include a computer monitor, or any other applicable display known to persons skilled in the relevant art(s) from the teachings herein.

As shown in FIG. 1, computer system 104 also comprises a rolled fingerprint capture module 108. Rolled fingerprint capture module 108 detects the start and stop of fingerprint rolls on fingerprint scanner 102. Furthermore, rolled fingerprint capture module 108 combines captured rolled fingerprint image frames into composite rolled fingerprint images. Further structural and operational details of rolled fingerprint capture module 108 are provided below. Rolled fingerprint capture module 108 may be implemented in hardware, firmware, software, or a combination thereof. Other structural embodiments for rolled fingerprint capture module 108 will be apparent to persons skilled in the relevant art(s) based on the discussion contained herein.

The present invention is described in terms of the exemplary environment shown in FIG. 1. However, the present invention can be used in any rolled fingerprint capture environment where a fingerprint scanner that captures rolled fingerprint images is interfaced with a display that displays fingerprint images. For instance, in one embodiment, fingerprint scanner 102 and/or display 106 may comprise rolled fingerprint capture module 108. In such an embodiment, fingerprint scanner 102 may be coupled to display 106, and computer system 104 may not be necessary in part or in its entirety. Such embodiments are within the scope of the present invention.

Description in these terms is provided for convenience only. It is not intended that the invention be limited to application in this example environment. In fact, after reading the following description, it will become apparent to a person skilled in the relevant art how to implement the invention in alternative environments known now or developed in the future.

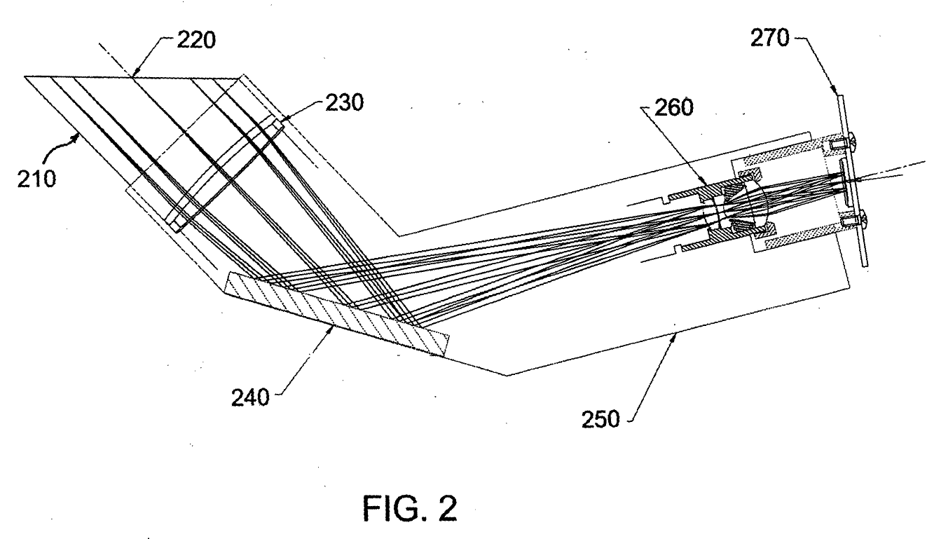

FIG. 2 shows an example of an optical subsystem that can be used in fingerprint scanner 102 (shown in FIG. 1). A prism 210 has a platen surface 220. A finger to be imaged is rolled across platen surface 220. A finger lens 230 forms an image of the rolled finger on mirror 240, which reflects the rolled finger image to rear lens cell 260. Rear lens cell 260 forms an image of the rolled finger on camera 270. Camera 270 may be, for example, a CMOS or CCD camera. As the finger is rolled, camera 270 captures a plurality of image frames of the finger in different positions on platen surface 220.

Implementations for a rolled fingerprint capture module 108 are described at a high-level and at a more detailed level. These structural implementations are described herein for illustrative purposes, and are not limiting. In particular, the rolled fingerprint capture module 108 as described in this section can be achieved using any number of structural implementations, including hardware, firmware, software, or any combination thereof. The details of such structural implementations will be apparent to persons skilled in the relevant art(s) based on the teachings contained herein.

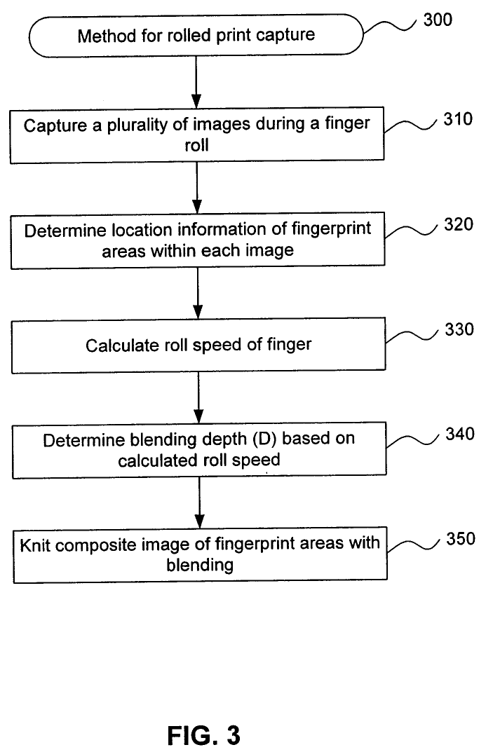

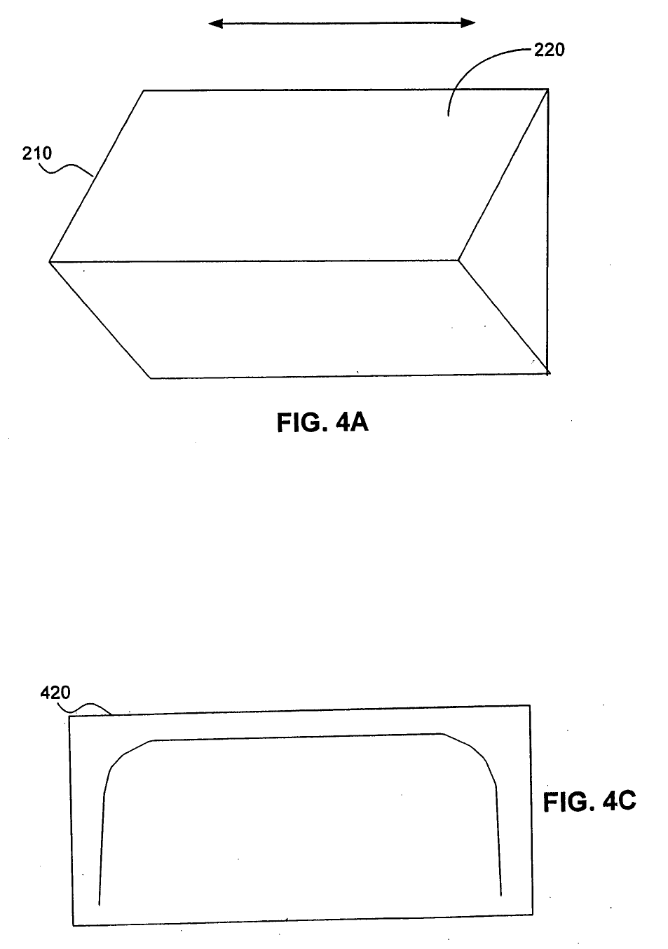

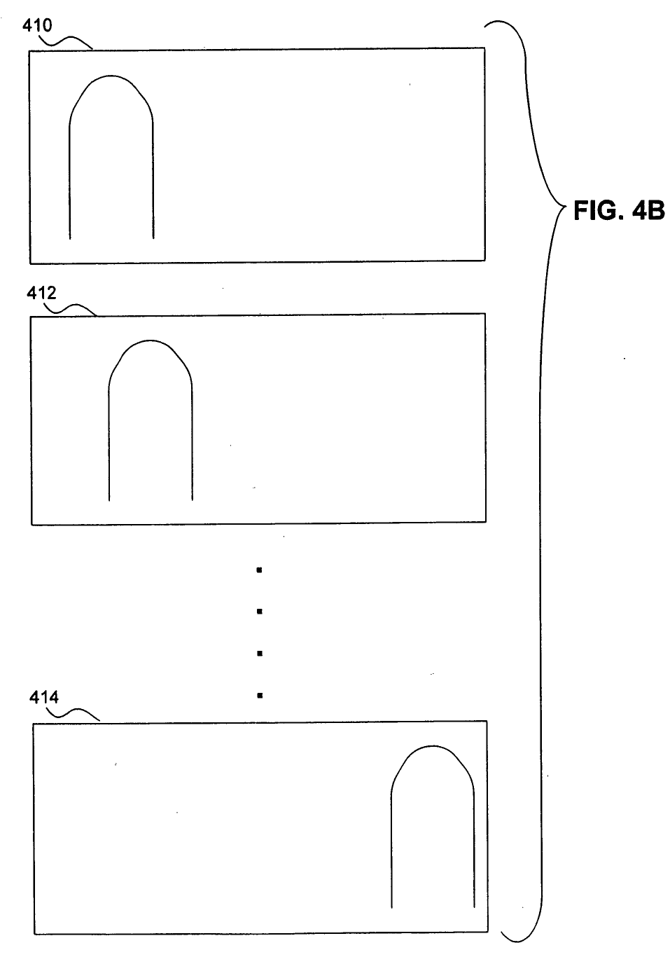

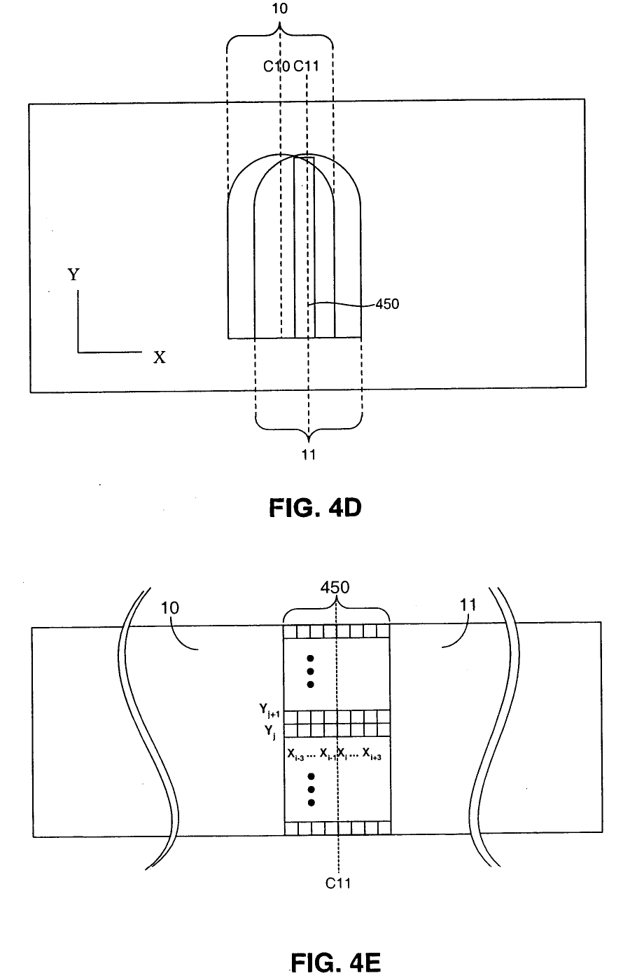

FIG. 3 is a flow chart showing a method 300 for rolled print capture wherein a series of rolled print images are blended together to form a single fingerprint image, taking into account the roll speed of the finger during image capture according to an embodiment of the present invention (steps 310-350). As shown in FIG. 3, a plurality of images are captured during a finger roll (step 310). Next, in step 320, the areas of each image that contain fingerprint information are identified. In step 330, roll speed of the finger is calculated. A blending depth is calculated based on calculated roll speed of the finger in step 340. In step 350, a composite image of the fingerprint areas is generated with blending. The operation of each of these steps 310-350 is described further below with reference to FIGS. 4a through 4e.

FIG. 4a shows prism 210 with platen surface 220 against which a fingertip may be rolled laterally, in the direction of the arrow. FIG. 4b shows a sequence of images of the imaging surface of FIG. 4a as a finger is rolled across the imaging surface. A first image 410 is captured with the left side of the finger against the platen, and the finger is rolled against the platen about the central longitudinal axis of the finger while a second image 412 and subsequent images are captured. In step 310 (shown in FIG. 3), the capture of sequential images continues until the finger has been rolled completely from left to right, sequentially presenting the entire fingerprint area for imaging, and concludes with image 414 of the right side of the finger. Capture occurs at a relatively fast frame rate, such as 15 or more frames per second, so there is substantial overlap between succeeding images of the fingertip. For those portions of the finger located in these overlap or boundary regions, there is data available from more than one image frame. FIG. 4c shows an image 420 of the platen area over which the finger rolls during image capture.

The image data collected may be in any data format and resolution and may use any current or future imaging technology. The example described herein uses 8-bit gray scale image data, but the image data may have a higher or lower resolution, may be a color image, or may relate to an image other than a visible wavelength image, for example an infrared image.

As part of the process of collecting the series of fingertip images and stitching them together to form a composite roll print image, imaging artifacts are discarded; that is, only the data from the fingertip region of interest (referred to as the centroid window) is used for further processing and any image information in other areas is ignored (step 320). Isolation of the centroid window data may be achieved by filtering the image, binarizing the data to obtain a black and white image, localizing the resulting dark areas, ordering the dark areas by size, and selecting the largest dark area as the centroid window area. Then, the original gray scale data for that area is used as an input to the composite roll print image and image data from that frame for other areas of the platen is discarded.

Various methods useful in processing the series of images as the finger is rolled, including further details of methods for identifying and selecting the centroid window for each image, are disclosed in U.S. Pat. No. 6,483,932 to Martinez et al., assigned to the assignee of this application, the entire disclosure of which is incorporated herein by reference.

FIG. 4d shows, in combination, two sequentially captured fingertip image centroid windows, arbitrarily labeled 10 and 11, and illustrates a preferred manner of combining sequentially captured fingertip images to form a composite roll print image. The composite image formation process will be described in terms of combining data from the two centroid windows 10 and 11, but it should be understood that a much larger number of sequentially captured images are typically combined in the manner shown to obtain a complete roll print image. As shown in FIG. 4d, centroid window 10 contains an image of a fingertip and has a centerline C10. Centroid window 11 contains an image of the same fingertip as centroid window 10, but taken at a time subsequent to the image of centroid window 10 and thus showing a slightly different portion of the fingertip as it rolls across the surface. Centroid window 11 has a centerline C11.

The location of centerline C10 may be calculated by identifying the lines defining the left and right sides of centroid window 10, determining the X coordinate of those lines, adding these two X coordinates, and dividing the result by two. In this manner, the X coordinate of the approximate center of centroid window C10 can be established. Similarly, the location of centerline C11 may be calculated by adding together the X coordinates of the lines defining the left and right sides of centroid window 11 and dividing the result by two.

A blending area 450 is located in a region of overlap between centroid windows 10 and 11. In one embodiment, as illustrated in FIG. 4d, centerline C11 is selected as a stitch line for combining data from centroid windows 10 and 11 into a composite image. Blending area 450 is centered about the selected stitch line (centerline C11), and extends to encompass a plurality of pixels on each side of centerline C11.

FIG. 4e illustrates blending of data at the stitch line C11 located at X=Xᵢ. The image data to the left of stitch line C11 (having coordinates X=Xᵢ₋ₙ to Xᵢ₋₁ where n is the distance to the next adjacent stitch line) is taken from centroid window 10, while image data to the right of stitch line C11 (coordinates X=Xᵢ to Xᵢ₊ₙ) is taken from the image of centroid window 11. If centroid window 10 is the first image to be assembled into the composite image, data from the entire centroid window 10 is used in the composite image. If there are further images to the left of centroid window 10 that are to be assembled into the composite image, the image data from centroid window 10 is used only between stitch lines C10 and C11, and image data from centroid window 10 is blended with image data from a centroid window 9 to the left (not shown) around stitch line C10 between centroid windows 9 and 10.

This process is illustrated by a single stitching and blending operation between centroid windows 10 and 11 in FIG. 4d, but it should be understood that stitching and blending of the image data from each centroid window occurs in the same manner for all adjacent centroid windows within a rolled print.

To increase accuracy and quality of the resulting composite image, the gray scale values of pixels near the stitch lines are determined based on a blended weighting of the pixel values from two overlapping images providing data for that pixel location. A preferred embodiment of this blending process will now be described in detail. For simplicity, the operation of the inventive blending process (including steps 330 through 350 as illustrated in FIG. 3) will be explained and shown in the drawings in terms of images of fingers rolled from left to right in the imaging area. The invention is not so limited, and preferably the same blending operations are provided for images obtained when fingers are rolled from right to left, with the algorithms adjusted appropriately.

First, a desired blending depth “Blend_Depth” is calculated. The desired blending depth is preferably calculated according to a predetermined algorithm based at least in part on roll speed of the finger. In a preferred embodiment blending depth is determined by the following equation:
Blend_Depth=Roll_Speed*0.7 (Equation 1)
The resulting value for Blend_Depth in this embodiment is in units of pixels and defines the number of pixels to the right and to the left of the stitching line that the blending process will modify. Roll_Speed can be defined to be any value varying with the roll speed of the finger, and is defined in a preferred embodiment as the number of pixels a rolling finger moves between two subsequent video frames. The preferred definition produces a value for Roll_Speed in units of “pixels per frame interval.” Roll_Speed can be calculated and represented using a variety of other units representing a value that varies with movement speed of the finger, as desired. For example, Roll_Speed can be calculated in terms of inches per second. However, if Roll_Speed is calculated and represented in another unit format, Equation 1 must be modified to include a unit conversion factor so that the resulting Blend_Depth value is calculated in units of “pixels.”

To ensure that the blending depth is less than or equal to the number of available overlapping pixels a multiplier is provided in Equation 1, in this example 0.7. The value of the multiplier must be less than 1.0 and can be varied based on experimental results or preference. As can be seen, in this embodiment the blending depth (and the number of pixels blended on each side of the stitch line) increases as roll speed increases. Fewer pixels on each side of the stitch line are blended as the roll speed is reduced. In an embodiment using Equation 1 to determine blending depth, in effect, a specified percentage of the image area added to the composite image with each frame is blended. In one exemplary embodiment, each time a frame is stitched to the composite image 70% of the newly added image area is blended with data from the preceding image. As a further measure to avoid excessive blending depth, blending does not occur for pixels that are not within an overlap area. In other words, if there is no data available for a particular pixel from the adjacent image, that pixel will not be blended even though it may fall within the calculated blending region.

The algorithm for determining blend depth may also take into account factors in addition to roll speed, as desired, and such modifications are within the scope of the invention.

The composite image formation process requires stitching together data from a series of consecutive video frames of the finger roll area. Each stitching operation involves identifying a relevant image portion of a frame, adding that data to an image construct at a stitch line (e.g. C11) defining a border with image data from a previous frame, and performing a data blending process to adjust pixel values near the stitch line.

Pixels from the current video frame are copied to the right of the stitch line (that is, in the direction of the finger roll). Pixels from the previous video frame are located on the left of the stitch line (in the opposite direction of the finger roll). The blending process modifies the value of pixels located near the stitch line within a blending region 450, the width of which is two times Blend_Depth as calculated above. Values for blended pixels are calculated based on both (1) the value of the pixel in the main video frame for that pixel, and (2) the value of the pixel from an adjacent video frame that contains information for that pixel because that frame overlaps to some extent the main video frame for that pixel. In the example herein the pixel values are eight-bit gray scale values, although the invention encompasses a variety of other imaging techniques. The pixel value for the main video frame covering the pixel area is given more weight than data from the “overlap” frame.

Referring again to FIG. 4e, the blending process on the left of the stitch line (X<Xᵢ) is performed as follows. For each pixel in blending region 450:
(1) Determine Vp (value of pixel taken from the previous video frame, centroid window 10) and Vc (value of pixel taken from the current video frame, centroid window 11)
(2) Determine Ds (distance of the pixel from the stitch line C11)
(3) Calculate a blend number B=Vc+Ds*255/Blend_Depth
(4) Change the pixel value to the lower of Vp and B.

The blending process on the right of the stitch line (X≧Xᵢ) is performed as follows:
(1) Determine Vp (value of pixel in previous video frame, centroid window 10) and Vc (value of pixel in current video frame, centroid window 11)
(2) Determine Ds (distance of the pixel from the stitch line C11)
(3) Calculate a blend number B=Vp+Ds*255/Blend_Depth
(4) Change the pixel value to the lower of Vc and B.

As can be seen, for each pixel data from one of the frames is given primary weight and redundant data from the adjacent frame is given secondary weight. In the embodiment disclosed, the stitch line is the boundary for this weighting determining; to the left of stitch line C11 data from centroid window 10 has primary weight, and to the right data from centroid window 11 has primary weight. In addition, the weight given to the secondary data from the adjacent centroid window diminishes as distance from the stitch line increases.

As noted above, calculations in this example are based on eight bit gray scale image data. The multiplying value 255 used to calculate the blend number is selected based on 255 being the value of white and zero being the value of pure black in the gray scale. If a different scale or data resolution is used, or if non-gray scale data is used, the formulae are adjusted accordingly.

It is useful to establish a maximum allowable value for Roll_Speed, since rolling the finger too quickly may produce diminished print quality and may not produce an appropriate level of overlap of adjacent centroid windows to permit high quality image blending. In addition to the possibility of exceeding the frame rate capability of the imaging hardware, compression of the finger and its position relative to the platen often display significant variations at high roll speeds, resulting in less useful and reproducible image data. Maximum allowable roll speed can be determined experimentally based on experience with the hardware in use. In a preferred embodiment, maximum allowable roll speed is 90 pixels per video frame. Roll speeds greater than the predetermined value will trigger an indication that the user must re-roll the finger.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method for capture of a fingerprint image as a finger is rolled across a platen surface, comprising the steps of:
(a) capturing a plurality of fingerprint image frames, each captured frame including pixel data representative of a print on the platen surface at a time of capture as the finger is rolled across the platen surface; and
(b) combining said plurality of captured fingerprint image frames into a composite fingerprint image;
wherein said combining step includes at least partially blending pixel data in successive frames as a function of roll speed of the finger across the platen surface.

2. The method of claim 1 wherein said combining step includes the further step of identifying at least one boundary region in a plurality of captured fingerprint image frames and blending pixel data in said boundary region.

3. The method of claim 2 wherein said blending uses a blending function to calculate for said composite fingerprint image a pixel value for a number of pixels in said boundary region, said pixel value based on the values of a plurality of corresponding pixels in said plurality of fingerprint image frames, where said number of pixels varies with said roll speed of the finger.

4. The method of claim 3 wherein said blending function assigns a variable weight to a corresponding pixel value from an adjacent frame depending on distance of the pixel from a frame boundary.

5. The method of claim 3 wherein said blending is applied to determine the value of a majority of pixels in said boundary region.

6. The method of claim 1 wherein in said step of capturing a plurality of fingerprint image frames, said frames are captured periodically at equal intervals t as the finger is rolled across the platen surface.

7. The method of claim 6 comprising the further steps of:
identifying, within each fingerprint image frame, a subset region containing the fingerprint image; and
determining said roll speed based on the relative change in location of said subset regions between one captured fingerprint image frame selected as a roll speed reference frame, and a fingerprint image frame captured after capture of said roll speed reference frame.

8. A method for generating a composite fingerprint image in a rolled fingerprint capture system, comprising the steps of:
(a) capturing a first fingerprint image frame and a second fingerprint image frame as a finger is rolled across an imaging surface;
(b) identifying at least one boundary pixel representing corresponding fingerprint image data appearing in both the first and second image frames; and
(c) assigning a blended value to said boundary pixel where said blended value is a function of the values of corresponding pixels in said first and second fingerprint image frames and roll speed of the finger across the imaging surface during said capturing step; and
(d) combining said first and second fingerprint image frames into a composite fingerprint image incorporating said blended value for said boundary pixel.

9. The method of claim 8 wherein said step of assigning a blended value includes applying a blending function that assigns a variable weight to pixel data from said first and second frames depending on distance of the pixel from a frame boundary.

10. The method of claim 8 wherein said blended value is calculated for a majority of said boundary pixels.

11. The method of claim 8 wherein said step of capturing said first and second fingerprint image frames further includes capturing additional fingerprint image frames periodically at equal intervals t as the finger is rolled across the surface.

12. The method of claim 11 comprising the further steps of:
identifying, within each captured fingerprint image frame, a subset region containing the fingerprint image; and
determining said roll speed based on the relative change in location of said subset regions between one captured fingerprint image frame selected as a roll speed reference frame, and a fingerprint image frame captured after capture of said roll speed reference frame.

13. A method for generating a composite image of a finger moving across an imaging area, comprising the steps of:
(a) capturing a first image frame and a second image frame as the finger moves across the imaging area;
(b) determining a relative change in position of the finger between said first image frame and said second image frame;
(c) identifying a region containing pixels for which there is corresponding fingerprint image data in the first and second image frames; and
(d) for pixels in said region, assigning a blended value to said pixels where said blended value is a function of the values of corresponding pixels in said first and second image frames and said relative change in position of the finger between frames; and
(e) combining said first and second image frames into a composite fingerprint image incorporating said blended value for said pixels.

14. A system for capturing a fingerprint image as a finger is rolled across a platen surface, comprising:
image capture means for capturing a plurality of fingerprint image frames, each captured frame including pixel data representative of a print on the platen surface at a time of capture as the finger is rolled across the platen surface;
blending means for combining said plurality of captured fingerprint image frames into a composite fingerprint image,
wherein said blending means operates to blend pixel data from successive frames as a function of roll speed of the finger across the platen surface.

15. The system of claim 14 wherein said blending means further comprises means for identifying at least one boundary region appearing in a plurality of captured fingerprint image frames and containing corresponding fingerprint image information in said plurality of captured fingerprint image frames and blending pixel data in said boundary region.

16. The system of claim 15 wherein said blending means comprises means for calculating pixel values of a number of pixels in said composite fingerprint image based on the values of corresponding pixels in said plurality of fingerprint image frames, where said number of pixels varies with said roll speed of the finger.

17. The system of claim 16 wherein said blending function assigns a variable weight to data from adjacent frames depending on distance of the pixel from a frame boundary.

18. The system of claim 16 wherein said blending means uses blending to determine the value of a majority of pixels in said boundary region.

19. The system of claim 14 wherein said image capture means includes means for capturing frames periodically at equal intervals t as the finger is rolled across the platen surface.

20. The system of claim 19 further comprising:
means for identifying, within each fingerprint image frame, a subset region containing the fingerprint image; and
means for determining said roll speed based on the relative change in location of said subset regions between one captured fingerprint image frame selected as a roll speed reference frame, and a fingerprint image frame captured after capture of said roll speed reference frame.

21. A system for generating a composite fingerprint image in a rolled fingerprint capture system, comprising:
capture means for capturing a first fingerprint image frame and a second fingerprint image frame as a finger is rolled across an imaging surface;
blending means for identifying at least one boundary pixel representing corresponding fingerprint image data appearing in both the first and second image frames and assigning a blended value to said boundary pixel where said blended value is a function of the values of corresponding pixels in said first and second fingerprint image frames and roll speed of the finger across the imaging surface during said capturing step; and
image processing means for combining said first and second fingerprint image frames into a composite fingerprint image incorporating said blended value for said boundary pixel.

22. The system of claim 21 wherein said blending means calculates said blended value by assigning a variable weight to corresponding pixel data from an adjacent frame depending on distance of the pixel from a frame boundary.

23. The system of claim 21 wherein said blended value is calculated for a majority of said boundary pixels.

24. The system of claim 21 wherein said capture means comprises means for capturing fingerprint image frames periodically at equal intervals t as the finger is rolled across the surface.

25. The system of claim 24 further comprising roll speed determination means for identifying within a captured fingerprint image frame a subset region containing the fingerprint image and determining roll speed based on the relative change in location of said subset region between one captured fingerprint image frame selected as a roll speed reference frame, and a fingerprint image frame captured after capture of said roll speed reference frame.

26. A system for generating a composite image of a finger moving relative to an imaging area, comprising:
capture means for capturing a first image frame and a second image frame as the finger moves relative to the imaging area;
calculating means for determining a relative change in position of the finger between said first image frame and said second image frame;
processing means for identifying a region containing pixels for which there is corresponding fingerprint image data in the first and second image frames and assigning a blended value to said pixels where said blended value is a function of the values of corresponding pixels in said first and second image frames and said relative change in position of the finger between frames and combining said first and second image frames into a composite fingerprint image incorporating said blended value for said pixels.
